(19) United States
(12) Patent Application Publication
(10) Pub. No.: US 2007/0245924 A1
(43) Pub. Date: Oct. 25, 2007

(54) Reduced abrasion of titanium dioxide pigments produced from the chloride process

(76) Inventors: Michael Andrew Hofmann, Brookhaven, PA (US); Charles David Musick, Waverly, TN (US); Narayanan Sankara Subramanian, Hockessin, DE (US); Kostantinos Kourtakis, Media, PA (US); Austin Henry Reid JR., Wilmington, DE (US)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 11/407,736

(22) Filed: Apr. 20, 2006

(51) Int. Cl. C09D 11/00; C09C 1/36; C01G 23/047

(52) U.S. Cl. 106/31.9; 106/436; 106/437; 423/610; 423/611; 423/612; 523/160; 524/497

(57) ABSTRACT

Disclosed herein are pigments comprising mostly rutile TiO₂, wherein the mostly rutile TiO₂ consists essentially of low abrasion TiO₂ particles produced by introducing a metal halide into the chloride process. Further disclosed are ink, can coatings, fibers, papers, and plastics comprising the pigment. Also disclosed herein are pigments comprising the low abrasion TiO₂ pigments comprising TiO₂ particles which have been further heat treated at a temperature of at least about 800° C. in an oxidizing atmosphere for a time period of at least about 1 hour.

### FIELD OF THE INVENTION

Disclosed herein are low abrasion titanium dioxide pigments used in abrasion sensitive applications such as, for example, printing inks, can coating applications, fibers, papers, and plastics.

### BACKGROUND OF THE INVENTION

Low abrasion titanium dioxide particles are desirable in, for example, can coating, printing ink, fiber, paper, and plastic applications. A common belief in the marketplace is that a low abrasion pigment cannot be produced via the chloride route, but only using sulfate technology. Pigment abrasivity from the chloride process is typically highly variable, and Applicants do not know of any process controls that, when used together, allow for consistently low abrasion.

Co-owned U.S. Pat. No. 5,562,764 discloses a process for producing substantially anatase-free TiO₂ by addition of a silicon halide in a reaction of TiCl₄ and an oxygen-containing gas in a plug flow reactor is disclosed. Pigmentary properties such as gloss and CBU are enhanced without loss of durability.

Co-owned Published U.S. Patent Application No. 2004/0258610 discloses a process for making durable titanium dioxide pigment by vapor phase deposition of surface treatments on the titanium dioxide particle surface by reacting titanium tetrachloride vapor, an oxygen containing gas and aluminum chloride in a plug flow reactor to form a product stream containing titanium dioxide particles; and introducing silicon tetrachloride into the reactor at a point downstream of the point where the titanium tetrachloride and oxygen were contacted and where at least 97% of the titanium tetrachloride has been converted to titanium dioxide or where the reaction temperature is no greater than about 1200° C., and preferably not more than about 1100° C.

U.S. Pat. No. 6,562,314 discloses methods of producing substantially anatase-free titanium dioxide by mixing titanium tetrachloride with a silicon compound to form an admixture, and introducing the admixture and oxygen into a reaction zone to produce the substantially anatase-free titanium dioxide. The reaction zone has a pressure of greater than 55 psig.

There is a need for low abrasion grade titanium dioxide produced via a chloride process for use in, for example, can coating, printing ink, fiber, paper, and plastic applications without the attendant process variability problems that Applicants find associated with titanium dioxide produced via a chloride process in the absence of metal halide.

### SUMMARY OF THE INVENTION

One aspect relates to a pigment comprising mostly rutile TiO₂, wherein the mostly rutile TiO₂ consists essentially of low abrasion TiO₂ particles produced by introducing a metal halide into the chloride process.

Another aspect is for an ink, can coating, fiber, paper, or plastic comprising a pigment comprising mostly rutile TiO₂, wherein the mostly rutile TiO₂ consists essentially of low abrasion TiO₂ particles produced by introducing a metal halide into the chloride process

A further aspect relates to a pigment comprising mostly rutile TiO₂, wherein the mostly rutile TiO₂ consists essentially of low abrasion TiO₂ particles as described above, where the low abrasion TiO₂ particles are further heat treated at a temperature of at least about 800° C. in an oxidizing atmosphere for a time period of at least about 1 hour.

A further aspect relates to a method of producing low abrasion TiO₂ particles via the chloride process comprising introducing a metal halide into the chloride process at a point of addition which produces TiO₂ particles having a substrate abrasion of less than about 25 mg as measured by Daetwyler abrasion test; and optionally recovering the low abrasion TiO₂ particles.

Other objects and advantages will become apparent to those skilled in the art upon reference to the detailed description that hereinafter follows.

### DETAILED DESCRIPTION OF THE INVENTION

Applicants specifically incorporate the entire content of all cited references in this disclosure. Further, when an amount, concentration, or other value or parameter is given as either a range, preferred range, or a list of upper preferable values and lower preferable values, this is to be understood as specifically disclosing all ranges formed from any pair of any upper range limit or preferred value and any lower range limit or preferred value, regardless of whether ranges are separately disclosed. Where a range of numerical values is recited herein, unless otherwise stated, the range is intended to include the endpoints thereof, and all integers and fractions within the range. It is not intended that the scope of the invention be limited to the specific values recited when defining a range.

In the context of this disclosure, a number of terms shall be utilized.

By “mostly rutile TiO₂” is meant rutile TiO₂ containing less than about 25% anatase. In one embodiment, mostly rutile TiO₂ contains less than about 20%, in another embodiment, less than about 10%, in another embodiment, less than about 5% anatase TiO₂, in another embodiment less than about 2% anatase TiO₂, and in another embodiment less than about 1% anatase TiO₂.

By “low abrasion” is meant an ink containing TiO₂ pigment showing substrate (abrasive) weight loss using the Daetwyler method after 500,000 revolutions of less than about 25 mg, preferably less than about 20 mg, more preferably less than about 15 mg, and most preferably less than about 10 mg. The Daetwyler abrasion test examines the abrasion characteristics of a printing ink on a chrome-plated copper substrate under laboratory conditions representative of industrial gravure printing applications. The method uses a Daetwyler Abrasion Tester AT II (available from the Max Daetwyler Co., Huntersville, N.C.). This method can be used to rank the relative abrasion characteristics of TiO₂ grades. Abrasion is determined by measuring weight loss of the substrate after 500,000 revolutions in the presence of a TiO₂-containing ink. The test is performed as follows. Weighing of the doctor blades and substrate is performed before assembling the Daetwyler instrument. An ink is then prepared according to Table 1 from the TiO₂ sample to be measured

TABLE 1
Ink formula for abrasion testing

| Ingredient | Grams |
|---|---|
| Burnoc 18-472 Resin | 240 |
| Methyl Ethyl Ketone | 48 |
| Toluene | 48 |
| Titanium Dioxide | 240 |

Split ingredients between two one-quart friction top cans and add
220 grams of 0.2 mm glass beads as dispersion media to each can.
Place cans on a paint shaker off-center and shake for 45 minutes.
Reduction: add the following ingredients to ink and shake for 10
additional minutes.

| | |
|---|---|
| Methyl Ethyl Ketone | 30 |
| Toluene | 30 |

Strain final ink through a fine mesh paint strainer.

The ink is then loaded into the Daetwyler instrument and the instrument run for 500,000 revolutions. Once the test is complete, the Daetwyler instrument is disassembled and the substrate weighed after cleaning thoroughly. The abrasion of the TiO₂ sample used to prepare the ink is recorded as the substrate weight loss after the test.

By “point(s) of addition” is meant the site(s) at which metal halide is added to the chloride process. Herein, the “point(s) of addition” is anywhere in the TiCl₄ stream prior to the co-mixing with oxygen, and at any point in the reaction mass where the reaction mass temperature exceeds 1100° C. The reduction in abrasion for a given amount of metal halide is more dramatic for points at higher reaction mass temperature.

“Plug flow reactor” or “pipeline reactor” is defined herein to mean a reactor in the form of a conduit having a unidirectional flow at velocities of about 50 feet per second (about 15 m/s) or higher and exhibiting substantially little or no backmixing.

Pigment Comprising Mostly Rutile TiO₂

One aspect is for a pigment comprising mostly rutile TiO₂, wherein the mostly rutile TiO₂ consists essentially of low abrasion TiO₂ particles produced by introducing a metal halide into the chloride process. In another aspect, the mostly rutile TiO₂ pigment consists of low abrasion TiO₂ particles produced by introducing a metal halide into the chloride process.

Co-owned U.S. Pat. No. 5,562,764, incorporated herein by reference, discloses deposition of silicon halides at points downstream from TiCl₄ stream addition. In the present application, Applicants report the unexpected discovery that addition of metal halide to the oxidation reactor at a point closer to the addition of TiCl₄ (slot), addition of TiCl₄ and metal halide to the oxidation reactor at the same point (such as, e.g., by adding metal halide directly to the TiCl₄ stream or adding the metal halide as a separate stream, as described in U.S. Pat. No. 3,856,929, incorporated herein by reference), or addition of metal halide upstream of the oxidation reactor reduces the abrasiveness of the resulting TiO₂ pigment. Adding metal halide to the chloride process mitigates the deleterious effects of the process variability on pigment abrasivity.

In the chloride process, TiCl₄ is evaporated and preheated to temperatures of from about 300 to about 650° C. and introduced into a reaction zone of a reaction vessel. Typically, introduction of TiCl₄ into the reaction zone is effectuated through one or more streams, as described in, for example, U.S. Pat. No. 3,203,763, incorporated herein by reference.

Aluminum halide such as AlCl₃, AlBr₃ and AlI₃, preferably AlCl₃, in amounts sufficient to provide about 0.5 to about 10% Al₂O₃, in another embodiment about 0.5 to about 5%, and in another embodiment about 0.5 to about 2% by weight based on total solids formed in the oxidation reaction is thoroughly mixed with TiCl₄ prior to its introduction into a reaction zone of the reaction vessel. In alternative embodiments, the aluminum halide may be added partially or completely downstream of the reaction zone.

The oxygen containing gas is preheated to at least 1200° C. and is continuously introduced into the reaction zone through a separate inlet from an inlet for the TiCl₄ feed stream. Water tends to have a rutile promoting effect. It is desirable that the reactants be hydrous. For example, the oxygen containing gas comprises hydrogen in the form of H₂O and can range from about 0.01 to 0.3 wt % hydrogen based on TiO₂ produced, in another embodiment 0.02-0.2 wt %. Optionally, the oxygen containing gas can also contain a vaporized alkali metal salt such as inorganic potassium salts, organic potassium salts and the like, particularly preferred are CsCl or KCl, etc. to act as a nucleant.

In one embodiment, the metal halide is introduced anywhere in the TiCl₄ stream prior to the co-mixing with oxygen. In some embodiments, the metal halide is mixed with the aluminum halide prior to its introduction into the TiCl₄ stream. The metal halide can be introduced either by directly injecting the desired metal halide, or by forming the metal halide in situ. When forming in situ, a metal halide precursor elemental metal, for example, silicon, boron, phosphorus, or a mixture thereof is added to the TiCl₄ stream and reacted with a halide, for example, chlorine, iodine, bromine, or a mixture thereof to generate the metal halide.

In an embodiment where the metal halide is introduced anywhere in the TiCl₄ stream prior to the co-mixing with oxygen, the metal halide is added to the TiCl₄ stream or formed in situ at a rate sufficient to add metal oxide to the TiO₂ pigment to produce low abrasion TiO₂ pigment as defined above.

In another embodiment, the metal halide is added downstream from the TiCl₄ stream addition. The exact point of metal halide addition will depend on the reactor design, flow rate, temperatures, pressures and production rates, but can be determined readily by testing to obtain mostly rutile TiO₂ and the desired effect on abrasion. For example, the metal halide may be added at one or more points downstream from where the TiCl₄ and oxygen containing gas are initially contacted.

In one embodiment for downstream addition, metal halide is added downstream in the conduit or flue where scouring particles or scrubs are added to minimize the buildup of TiO₂ in the interior of the flue during cooling as described in greater detail in U.S. Pat. No. 2,721,626, incorporated herein by reference. In this embodiment, the metal halide can be added alone or at the same point with the scrubs. Specifically, the temperature of the reaction mass at the point or points of metal halide addition is greater than about 1100° C., at a pressure of about 5-100 psig, in another embodiment 15-70 psig, and in another embodiment 40-60 psig. The downstream point or points of metal halide addition can be up to a maximum of about 6 inside diameters of the flue after the TiCl₄ and oxygen are initially contacted.

As a result of mixing of the reactant streams, substantially complete oxidation of TiCl₄, AlCl₃ and metal halide takes place but for conversion limitations imposed by temperature and thermochemical equilibrium. Solid particles of TiO₂ form. The reaction product containing a suspension of TiO₂ particles in a mixture of chlorine and residual gases is carried from the reaction zone at temperatures considerably in excess of 1200° C. and is subjected to fast cooling in the flue. The cooling can be accomplished by any standard method.

The TiO₂ pigment is recovered from the cooled reaction products by, for example, standard separation treatments, including cyclonic or electrostatic separating media, filtration through porous media, or the like. The recovered TiO₂ may be subjected to surface treatment, milling, grinding, or disintegration treatment to obtain the desired level of agglomeration. It will be appreciated by those skilled in the art that the metal oxide added as disclosed herein offers the flexibility of reducing the amount of metal oxide added at a subsequent surface treatment step, if desired.

Metal halide added becomes incorporated as metal oxide and/or a metal oxide mixture in the TiO₂, meaning that the metal oxide and/or metal oxide mixture is dispersed in the TiO₂ particle and/or on the surface of TiO₂ as a surface coating. In one embodiment, metal halide will be added in an amount sufficient to provide from about 0.1 to about 10% metal oxide, in another embodiment about 0.3 to 5% metal oxide, and in another embodiment about 0.3 to 3% metal oxide by weight based on total solids formed in the oxidation reaction, or TiO₂ (basis). Typically, higher amounts of metal oxide are desirable to improve abrasion.

Heat Treatment of TiO₂ Particles

A further aspect is for a pigment, as described above, wherein the low abrasion TiO₂ particles produced via a chloride process described above are heat treated at a temperature of at least about 800° C. in an oxidizing atmosphere for a time period of at least about 1 hour. In one embodiment, the TiO₂ particles are heat treated at a temperature of at least about 800° C. to about 1200° C. In another embodiment, the TiO₂ particles are heat treated for a time period of less than about 48 hours.

Tube furnaces, rotary tube furnaces, vertical fluidized beds, or other similar devices can be used for the heating cycle in flowing air.

The heat treatment process can be used to convert any residual anatase in the pigment to rutile, improve the optical perfection of the rutile lattice, and further improve the optical properties of the material without increasing the abrasivity of the pigment. In addition, a heating process step could be used for processes in which low abrasion is required following a high temperature heating step and locally induced high temperatures, for example, a polymer composite which requires a high temperature heating step during manufacture.

Compared to normal TiO₂ oxidation pigment, heat treating the TiO₂ particles which have been produced by introducing the metal halide into the chloride process do not become substantially more abrasive. A normal TiO₂ oxidation pigment becomes substantially more abrasive after this heat treatment procedure in the Daetwyler test.

Can Coatings

In one aspect, the low abrasion TiO₂ pigments produced as described herein can be used in the surface coating of metal cans. Typically, metal containers are made using one of two processes, the two-piece can process and the three-piece can process. Using the two-piece can processes, for example, large rolls of aluminum sheet stock are continuously fed into a press (cupper) that forms a shallow cup. The cup is drawn and wall-ironed to form the body of the beverage can. The lid is attached after the can is filled with product.

Can exteriors are often roll-coated with a neutral color, for example white or grey, which is then oven-cured. Decorative inks are then put on, for example, with a rotary printer, and a protective varnish is roll-coated directly over the inks, then oven cured again.

Can interiors are spray-coated with “inside spray” using an airless spray nozzle. Inside sprays are again oven-cured or baked.

Steel tuna fish-style cans and traditionally-shaped food cans can also be made using the two-piece process.

The three-piece can process includes traditional steel food cans, pails, and drums. These cans are those, for example, that are opened either at the top or the bottom with a can opener. A rectangular sheet (body blank) is rolled onto a cylinder and soldered, welded, or cemented at the seam. One end is attached after the filling of the can with product.

Printing Inks

In another aspect, the low abrasion TiO₂ pigments can be used in printing ink processes. Table 2 below summarizes the major end use applications of printing inks, by major substrate and printing process.

TABLE 2
Printing Ink Processes (by Substrate and End Use)

| | Primary Printing | |
|---|---|---|
| Type of Substrate | Process | End Uses |
| Plastic Films | Flexo, Gravure | Flexible Packaging |
| Containerboard | Flexo, Letterpress | Corrugated Containers |
| Metal Foil | Flexo, Gravure | Flexible Packaging |
| Paperboard boxboard | Lithography, Gravure | Folding cartons, food |
| | | containers |
| Plastic | Lithography, Flexo | Containers |
| Coater papers | Lithography, Gravure | Magazines, catalogs, |
| | | labels |
| Uncoated papers | Lithography, | Books, directories, |
| | Letterpress | commercial print |
| Newsprint | Lithography, | Newspapers, |
| | Letterpress | supplements |
| Glass | Screen | Containers |
| Aluminum | Lithography | Containers |
| Textiles | Screen, digital | Clothing |

White inks are primarily used in packaging applications. The dominant technologies for white ink packaging applications include Flexography and Gravure. These technologies are discussed further below.

Flexography

Process: Rubber image transfer plates. Some Flexo products are capped, other not capped.

Applications include plastic film, plastic laminated paper compositions, thin metal foils and laminates of foil, plastic, and paper. However, a considerable portion of flexographic printing is for non-flexible packaging applications, including folding cartons and corrugated containers. Flexo is used to a smaller portion in the commercial printing market, such as, for example, for labels and business forms publications (e.g., books and catalogs), and in specialty applications such as, for example, gift wraps and wallpaper.

Formulations: Flexo inks are formulated to dry by absorption into the substrate or by solvent evaporation. The low viscosity inks are based on solvents such as, for example, water and alcohols, together with low levels of glycoethers, esters, and hydrocarbons. Film-forming polymers are, for example, polyamides, nitrocellulose, rosins, shellacs, and acrylics. Water-based flexo systems are used on absorbant paper surfaces such as, for example, Kraft corrugated containers and multiwall bags, and on films and foils. Solvent is used for plastic film, and water is used for paper products.

Gravure/Intaglio

Process: Engraved recessed cylinder.

Application: Gravure is a printing process primarily for large printers used in publication, packaging, and specialty gravure. Gravure printing produces high-quality graphics and is best suited for very long production runs.

Formulations: Publication gravure is solvent-based. Water-based printing are often used in the packaging gravure market.

Fibers

Another aspect is for fibers comprising the low abrasion TiO₂ pigments produced as described herein. Because the UV stabilization and hiding power of rutile TiO₂ is superior to that of anatase TiO₂, utilization of the low abrasion TiO₂ pigments described herein as fiber dyes provide fibers having the benefits of UV stabilization and hiding power along with desirable low abrasion.

Suitable fibers include, but are not limited to, natural fibers such as cellulose, cellulosic fibers, and rayon; polyolefins such as polyethylene and polypropylene; polyesters such as polycaprolactone (“PCL”), poly(ethylene terephthalate) (“PET”), poly(butylene terephthalate) (“PBT”), poly(trimethylene terephthalate) (Sorona®, E.I. du Pont de Nemours and Company) and a liquid crystal polymer (e.g., Vectran®, Kuraray Co.); polyamides such as nylon 6, nylon 11, nylon 12, and nylon 6,6; poly(ether-amides) such as, but not limited to, Pebax® 4033 SA and Pebax® 7233 SA (Arkema Corp.); poly(ether-esters) such as, but not limited to, Hytrel® 4056 (E.I. du Pont de Nemours and Company) and Riteflex® (Hoechst-Celanese); fluorinated polymers such as poly(vinylidine fluoride) and poly(tetrafluoroethylene); and combinations thereof, including bicomponent fibers, which may be core-sheath fibers. Texturized fibers may also be used.

Methods of dyeing fibers with TiO₂ pigments are well known in the art (see, e.g., Hanna T. R. & Subramanian N. S., “Rutile titanium dioxide for fiber applications”, 2004 fibertech® Conference, Chattanooga, Tenn., incorporated herein by reference).

The bicomponent fibers may have cross-sectional shapes such as round; trilobal; cross; and others known in the art. The core-sheath bicomponent fibers are typically made such that the sheath of the fibers utilizes a lower melting point polymer than the core polymer.

Suitable polymers for the core include polyamides such as, but not limited to, nylon 6, nylon 11, nylon 12, and nylon 6,6; polyesters such as, but not limited to, PET and PBT; poly(ether-amides) such as, but not limited to, Pebax® 4033 SA and Pebax® 7233 SA; poly(ether-esters) such as, but not limited to, Hytrel® 4056 and Riteflex®; polyolefins such as, but not limited to, polypropylene and polyethylene; and fluorinated polymers, such as, but not limited to, poly(vinylidene fluoride); and mixtures thereof.

Suitable polymers for the sheath include polyolefins such as, but not limited to, polyethylene and polypropylene; polyesters such as, but not limited to, PCL; poly(ether-amides) such as, but not limited to, Pebax® 4033 SA and Pebax® 7233 SA; poly(ether-esters) such as, but not limited to, Hytrel® and Riteflex®; elastomers made from polyolefins, for example Engage® elastomers (DuPont Dow Elastomers LLC); poly(ether urethanes) such as, but not limited to, Estane® poly(ether urethanes) (BF Goodrich); poly(ester urethanes) such as, but not limited to, Estanee poly(ester urethanes); Kraton® polymers (Shell Chemical Company) such as, but not limited to poly(styrene-ethylene/butylene-styrene); and poly(vinylidene fluoride) copolymers, such as, but not limited to, Kynarflex 2800, (Elf Atochem).

The ratio of the two components of the core-sheath fibers can be varied. All ratios used herein are based on volume percents. The ratio may range from about 10 percent core and about 90 percent sheath to about 90 percent core and about 10 percent sheath, preferably from about 20 percent core and about 80 percent sheath to about 80 percent core and about 20 percent sheath, more preferably from about 30 percent core and about 70 percent sheath to about 70 percent core and about 30 percent sheath.

Papers

Methods of adding TiO₂ pigments to paper as fillers and/or coating pigments are well known in the art (see, e.g., Pigments for Paper: Titanium Dioxide, Hagemeyer R. W. ed., pp. 157-86, TAPPI Press, Atlanta, Ga., incorporated herein by reference). The paper is usually prepared from a mixture of water, cellulose fibers, and the low abrasion titanium dioxide pigments disclosed herein, optionally in the presence of an agent for improving the wet strength of the paper. An exemplary agent for improving the wet strength is a quaternary ammonium salt of epichlorohydrin-based polymers (for example epichlorohydrin/dimethylamine polymers).

There are many different grades of paper made, thus requiring a range of pigment content, from about 1% to 25% by weight on a dry basis. When titanium dioxide is added to paper, it may account for about 1% to 10% or more of the weight of the paper depending on the desired improvement in opacity.

Another aspect relates to the use of the low abrasion titanium dioxide pigments disclosed herein in the production of paper laminates based on paper containing the low abrasion titanium dioxide pigment and at least one resin (in particular a melamine or melamine-formaldehyde resin). Any paper laminate production process known to those skilled in the art may be employed (using a paper pigmented with the low abrasion titanium dioxide pigment disclosed herein) in order to prepare the laminates. The disclosure herein is not limited to one specific production process. Thus, for example, the pigmented paper may be impregnated with an aqueous-alcoholic solution of resin, after which several sheets of pigmented paper impregnated with resin are laminated by hot-pressing techniques. The pigmented paper may contain an agent for improving the wet strength of the paper.

Plastics

Plastics and/or resins to which the low abrasion titanium dioxide pigments disclosed herein can be added include essentially any plastic and/or resin. Included in the definition of plastic are rubber compounds. Methods of incorporating TiO₂ pigments into plastics are well known in the art (see, e.g., “International Plastics Handbook”, 2nd Edition, Saechtling, N.Y. (1987), incorporated herein by reference). For example, the low abrasion titanium dioxide pigments disclosed herein may be supplied to plastics and/or resins while the same is in any liquid or compoundable form such as a solution, suspension, latex, dispersion, and the like.

Suitable plastics and resins include, by way of example, thermoplastic and thermosetting resins and rubber compounds (including thermoplastic elastomers). The plastics and resins containing the low abrasion titanium dioxide pigments disclosed herein may be employed, for example, for molding (including extrusion, injection, calendering, casting, compression, lamination, and/or transfer molding), coating (including lacquers, film bonding coatings, powder coatings, coatings containing oily pigment and resin, and painting), inks, dyes, tints, impregnations, adhesives, caulks, sealants, rubber goods, and cellular products. Thus, the choice and use of the plastics and resins with the low abrasion titanium dioxide pigments disclosed herein are essentially limitless. For simple illustration purposes, the plastics and resins may be alkyd resins, oil modified alkyd resins, unsaturated polyesters employed in GRP applications, natural oils (e.g., linseed, tung, soybean), epoxides, nylons, thermoplastic polyester (e.g., polyethyleneterephthalate, polybutyleneterephthalate), polycarbonates, polyethylenes, polybutylenes, polystyrenes, styrene butadiene copolymers, polypropylenes, ethylene propylene co- and terpolymers, silicone resins and rubbers, SBR rubbers, nitrile rubbers, natural rubbers, acrylics (homopolymer and copolymers of acrylic acid, acrylates, methacrylates, acrylamides, their salts, hydrohalides, etc.), phenolic resins, polyoxymethylene (homopolymers and copolymers), polyurethanes, polysulfones, polysulfide rubbers, nitrocelluloses, vinyl butyrates, vinyls (vinyl chloride and/or vinyl acetate containing polymers), ethyl cellulose, the cellulose acetates and butyrates, viscose rayon, shellac, waxes, ethylene copolymers (e.g., ethylene-vinyl acetate copolymers, ethylene-acrylic acid copolymers, ethylene-acrylate copolymers), and the like.

All of the compositions and methods disclosed and claimed herein can be made and executed without undue experimentation in light of the present disclosure. It will be apparent to those of skill in the art that variations may be applied to the compositions and methods and in the steps or in the sequence of steps of the method described herein without departing from the concept, spirit, and scope of the invention. More specifically, it will be apparent that certain agents which are chemically related may be substituted for the agents described herein while the same or similar results would be achieved. All such similar substitutes and modifications apparent to those skilled in the art are deemed to be within the spirit, scope, and concept of the invention as defined by the appended claims.

### EXAMPLES

The present invention is further defined in the following Examples. It should be understood that these Examples are given by way of illustration only. From the above discussion and these Examples, one skilled in the art can ascertain the preferred features of this invention, and without departing from the spirit and scope thereof, can make various changes and modifications of the invention to adapt it to various uses and conditions.

### Example 1

TiCl₄ vapor containing vaporized AlCl₃ was heated and continuously admitted to the upstream portion of a vapor phase reactor of the type described in U.S. Pat. No. 3,203,763. Simultaneously, oxygen was heated to 1500° C. and admitted to the same reaction chamber through a separate inlet. Aluminum chloride was added at a rate sufficient to produce 1.3% Al₂O₃ on the collected oxidation reactor discharge. The reactant streams were rapidly mixed. The gaseous suspension of TiO₂ was then quickly cooled in the flues. The titanium dioxide pigment was separated from the cooled gaseous products by conventional means. A sample of reactor discharge were collected for a control measurement.

The production rate was lowered, and the aluminum addition level was increased to 2.3% Al₂O₃. Silicon tetrachloride was injected into the TiCl₄ stream prior to the mixing with oxygen at rate sufficient to add 1% SiO₂ to the pigment. About 90% rutile conversion was obtained with the remaining TiO₂ as anatase. Abrasion was measured on both sets of reactor discharge and the data is shown in Table 3.

TABLE 3

| | | Weight Loss of |
|---|---|---|
| Sample Description | Addition Point | Substrate (mg) |
| Control | | 37.45 |
| Test Sample | Upstream in TiCl₄ | 2.75 |

### Example 2

TiCl₄ vapor containing vaporized AlCl₃ was heated and continuously admitted to the upstream portion of a vapor phase reactor of the type described in U.S. Pat. No. 3,203,763. Simultaneously, oxygen was heated to 1500° C. and admitted to the same reaction chamber through a separate inlet. Aluminum chloride was added at a rate sufficient to produce 1.3% Al₂O₃ on the collected oxidation reactor discharge. The reactant streams were rapidly mixed. The gaseous suspension of TiO₂ was then quickly cooled in the flues. The titanium dioxide pigment was separated from the cooled gaseous products by conventional means. A sample of reactor discharge were collected for a control measurement.

Elemental silicon was added to the TiCl₄ stream and reacted with Cl₂ to generate silicon tetrachloride in situ. Silicon was added at a rate sufficient to add 0.11% SiO₂ to the pigment. The pigment produced was greater than 99.5% rutile. Abrasion was measured on both sets of reactor discharge and the data is shown in Table 4.

TABLE 4

| | | Weight Loss of |
|---|---|---|
| Sample Description | Addition Point | Substrate (mg) |
| Control | | 66.64 |
| Test Sample | Upstream in TiCl₄ | 41.07 |

### Example 3

TiCl₄ vapor containing vaporized AlCl₃ was heated and continuously admitted to the upstream portion of a vapor phase reactor of the type described in U.S. Pat. No. 3,203,763. Simultaneously, oxygen was heated to 1540° C. and admitted to the same reaction chamber through a separate inlet. Aluminum chloride was added at a rate sufficient to produce 1.1% Al₂O₃ on the collected oxidation reactor discharge. The reactant streams were rapidly mixed. The gaseous suspension of TiO₂ was then quickly cooled in the flues. The titanium dioxide pigment was separated from the cooled gaseous products by conventional means. Two samples of reactor discharge were collected for a control measurement.

Silicon tetrachloride was then injected into the reaction mass downstream of the mixing location by the method described in U.S. Pat. No. 5,562,764. Silicon tetrachloride was added at a rate sufficient to generate 1.1% SiO₂ on the pigment. The pigment produced was greater than 99.5% rutile. Abrasion was measured on both sets of reactor discharge and the results shown in Table 5.

TABLE 5

| | | Weight Loss of |
|---|---|---|
| Sample Description | Addition Point | Substrate (mg) |
| Control 1 | | 47.94 |
| Control 2 | | 59.47 |
| Test Sample | Downstream of Mix Location | 17.37 |
| | Where Temperature is Above | |
| | 1100° C. | |

### Comparative Example 1

TiCl₄ vapor containing vaporized AlCl₃ was heated and continuously admitted to the upstream portion of a vapor phase reactor of the type described in U.S. Pat. No. 3,203,763. Simultaneously, oxygen was heated to 1500° C. and admitted to the same reaction chamber through a separate inlet. Aluminum chloride was added at a rate sufficient to produce 1.3% Al₂O₃ on the collected oxidation reactor discharge. The reactant streams were rapidly mixed. The gaseous suspension of TiO₂ was then quickly cooled in the flues. The titanium dioxide pigment was separated from the cooled gaseous products by conventional means. A sample of reactor discharge were collected for a control measurement.

Silicon tetrachloride was then injected into the reaction mass downstream of the mixing location by the method described in Published U.S. Patent Application No. 2004/0258610. The injection temperature was around 1000° C. Silicon tetrachloride was added at a rate sufficient to generate 2.0% SiO₂ on the pigment. The pigment produced was greater than 99.5% rutile. Abrasion was measured on both sets of reactor discharge and the results shown in Table 6.

TABLE 6

| | | Weight Loss of |
|---|---|---|
| Sample Description | Addition Point | Substrate (mg) |
| Control | | 40.11 |
| Test Sample | Downstream of Mix Location | 39.67 |
| | Where Temperature is Below | |
| | 1100° C. | |

### Example 4

TiCl₄ vapor containing vaporized AlCl₃ was heated and continuously admitted to the upstream portion of a vapor phase reactor of the type described in U.S. Pat. No. 3,203,763. Simultaneously, oxygen was heated to 1540° C. and admitted to the same reaction chamber through a separate inlet. Aluminum chloride was added at a rate sufficient to produce 1.35% Al₂O₃ on the collected oxidation reactor discharge. The reactant streams were rapidly mixed. The gaseous suspension of TiO₂ was then quickly cooled in the flues. The titanium dioxide pigment was separated from the cooled gaseous products by conventional means. One sample of reactor discharge was collected for a control measurement.

Silicon tetrachloride was then injected into the reaction mass downstream of the mixing location by the method described in U.S. Pat. No. 5,562,764. Silicon tetrachloride was added at a rate sufficient to generate 0.5% SiO₂ on the pigment. The pigment produced was greater than 99.5% rutile. Abrasion was measured on both sets of reactor discharge and the results shown in Table 7.

TABLE 7

| | | Weight Loss of |
|---|---|---|
| Sample Description | Addition Point | Substrate (mg) |
| Control | | 11.96 |
| Test Sample | Downstream of Mix Location | 7.14 |
| | Where Temperature is Above | |
| | 1100° C. | |

### Example 5

300 g of TiO₂ pigment produced via a SiCl₄ co-oxidation process was loaded into a 4 inch diameter quartz tube placed in a horizontal tube furnace. An air flow rate of 0.9 liters/minute was used during the heating cycle. The temperature was increased to 1125-1150° C. at a rate of 5.5° C./minute. The pigment was soaked at 1125-1150° C. for 24 hours. Following this calcination cycle, the pigment was removed from the tube and ground lightly before being heated for another 24 hours using the same heating protocol. Following this procedure and prior to testing for abrasion, the pigment was ground to break up any aggregates.

Abrasion testing was performed on an ink prepared according to the procedures for and tested in a Daetwyler abrasion tester as described above (see Table 8).

### Comparative Example 2

300 g of TiO₂ pigment produced via without SiCl₄ co-oxidation was loaded into a 4 inch diameter quartz tube placed in a horizontal tube furnace. An air flow rate of 0.9 liters/minute was used during the heating cycle. The temperature was increased to 1050-1100° C. at a rate of 5.5° C./minute. The pigment was soaked at 1125-1150° C. for 24 hours. Following this calcination cycle, the pigment was removed from the tube and ground lightly before being heated for another 24 hours. Following this procedure and prior to testing for abrasion, the pigment was ground to break up any aggregates.

Abrasion testing was performed on an ink prepared according to procedures for and tested in a Daetwyler abrasion tester as described above (see Table 8).

TABLE 8

| | Substrate Abrasion | Substrate Abrasion |
|---|---|---|
| | Before Heating (mg) | After Heating (mg) |
| Example 5 | 7.05 | 8.09 |
| Comparative Example 2 | 11.96 | 35.7 |

Prior to heating, the SiCl₄ co-oxidation sample, with SiCl₄ added at the scrubs T (Example 5), is only slightly less abrasive than the control where no SiCl₄ was added. After heating to 1125-1150° C. for 48 hours, however, the SiCl₄ sample was still non-abrasive. The control, Comparative Example 2, became more abrasive.

1. A pigment comprising mostly rutile TiO₂, wherein the mostly rutile TiO₂ consists essentially of low abrasion TiO₂ particles produced by introducing a metal halide into the chloride process.

2. The pigment of claim 1, wherein the mostly rutile TiO₂ consists of low abrasion TiO₂ particles produced by introducing a metal halide into the chloride process.

3. The pigment of claim 1, wherein the metal halide is a silicon halide.

4. The pigment of claim 3, wherein the silicon halide is SiCl₄, SiBr₄, SiI₄, or a mixture thereof.

5. The pigment of claim 1, wherein the metal halide is a metal chloride.

6. The pigment of claim 5, wherein the metal chloride is BCl₃, PCl₃, or a mixture thereof.

7. The pigment of claim 1, wherein the low abrasion TiO₂ particles have a substrate abrasion of less than about 25 mg as measured by Daetwyler abrasion test.

8. The pigment of claim 7, wherein the low abrasion TiO₂ particles have a substrate abrasion of less than about 20 mg as measured by Daetwyler abrasion test.

9. The pigment of claim 8, wherein the low abrasion TiO₂ particles have a substrate abrasion of less than about 15 mg as measured by Daetwyler abrasion test.

10. The pigment of claim 9, wherein the low abrasion TiO₂ particles have a substrate abrasion of less than about 10 mg as measured by Daetwyler abrasion test.

11. The pigment of claim 1, wherein the mostly rutile TiO₂ contains less than about 25% anatase TiO₂.

12. The pigment of claim 11, wherein the mostly rutile TiO₂ contains less than about 20% anatase TiO₂.

13. The pigment of claim 12, wherein the mostly rutile TiO₂ contains less than about 10% anatase TiO₂.

14. The pigment of claim 13, wherein the mostly rutile TiO₂ contains less than about 5% anatase TiO₂.

15. The pigment of claim 14, wherein the mostly rutile TiO₂ contains less than about 2% anatase TiO₂.

16. The pigment of claim 15, wherein the mostly rutile TiO₂ contains less than about 1% anatase TiO₂.

17. An ink or can coating composition comprising the pigment of claim 1.

18. The can coating composition of claim 17, wherein the can coating composition is applied to a can produced by a two-piece can process or a three-piece can process.

19. The ink of claim 17, wherein the ink is applied to plastic film, containerboard, metal foil, paperboard boxboard, plastic, coater paper, uncoated paper, newsprint, glass, aluminum, or textile.

20. The Ink of claim 17, wherein the ink is applied by a flexo, gravure, letterpress, litho, screen, or digital printing process.

21. The ink of claim 17, wherein the ink is applied to flexible packaging, corrugated container, folding carton, food container, magazine, catalog, label, book, directory, newspaper, newspaper supplement, or clothing.

22. A fiber comprising the pigment of claim 1.

23. The fiber of claim 22, wherein the fiber is selected from the group consisting of a natural fiber, a polyolefin, a polyester, a polyamide, a poly(ether-amide), a poly(ether-ester), a fluorinated polymer, a bicomponent fiber, or a combination thereof.

24. The fiber of claim 23, wherein the natural-fiber is selected from the group consisting of cellulose, cellulosic fiber, and rayon.

25. The fiber of claim 23, wherein the polyolefin is selected from the group consisting of polyethylene and polypropylene.

26. The fiber of claim 23, wherein the polyester is selected from the group consisting of polycaprolactone, poly(ethylene terephthalate), poly(butylene terephthalate), poly(trimethylene terephthalate), and a liquid crystal polymer.

27. The fiber of claim 23, wherein the polyamide is selected from the group consisting of nylon 6, nylon 11, nylon 12, and nylon 6,6.

28. The fiber of claim 23, wherein the fluorinated polymer is selected from the group consisting of poly(vinylidine fluoride) and poly(tetrafluoroethylene).

29. A paper comprising the pigment of claim 1, wherein the pigment is a filler and/or a coating.

30. A plastic or resin comprising the pigment of claim 1.

31. The plastic or resin of claim 30, wherein the plastic or resin is a thermoplastic resin, a thermosetting resin, or a rubber compound.

32. The plastic or resin of claim 30, wherein the plastic or resin is employed for molding, coating, inks, dyes, tints, impregnations, adhesives, caulks, sealants, rubber goods, or cellular products.

33. The plastic or resin of claim 30, wherein the plastic or resin is an alkyd resin, oil modified alkyd resin, unsaturated polyester employed in GRP applications, natural oil, epoxide, nylon, thermoplastic polyester, polycarbonate, polyethylene, polybutylene, polystyrene, styrene butadiene copolymer, polypropylene, ethylene propylend copolymer, ethylene propylene terpolymers, silicone resin, silicone rubber, SBR rubber, nitrile rubber, natural rubber, acrylic, phenolic resin, polyoxymethylene, polyurethane, polysulfone, polysulfide rubber, nitrocellulose, vinyl butyrate, vinyl, ethyl cellulose, cellulose acetate, cellulose butyrate, viscose rayon, shellac, wax, or ethylene copolymer.

34. The pigment of claim 1, wherein the low abrasion TiO₂ particles are heat treated at a temperature of at least about 800° C. in an oxidizing atmosphere for a time period of at least about 1 hour.

35. The pigment of claim 34, wherein the low abrasion TiO₂ particles are heat treated at a temperature of at least about 800° C. to about 1200° C.

36. The pigment of claim 35, wherein the low abrasion TiO₂ particles are heat treated for a time period of less than about 48 hours.

37. A method of producing low abrasion mostly rutile TiO₂ pigment via a chloride process in which a TiCl₄ stream and oxygen are reacted in an oxidation reactor, comprising:
(a) introducing a silicon halide into the TiCl₄ stream in the chloride process at a point of addition upstream of the oxidation reactor and where a reaction mass containing the TiCl₄ stream is at a temperature which exceeds 1100° C. at a pressure of 5-100 psig, which produces low abrasion mostly rutile TiO₂ particles having a substrate abrasion of less than about 25 mg as measured by a Daetwyler abrasion test; and
(b) recovering the TiO₂ particles to obtain a pigment consisting essentially of the low abrasion mostly rutile TiO₂.

38-39. (canceled)

40. The method of claim 37 comprising after step (a) or (b) the further step of heat treating the TiO₂ particles at a temperature of at least about 800° C. in an oxidizing atmosphere for a time period of at least about 1 hour.
